(19) United States
(12) Patent Application Publication
(10) Pub. No.: US 2009/0033512 A1
(43) Pub. Date: Feb. 5, 2009

(54) User Programmable Architecture for Control of a Light Device Used with an Information Handling System Chassis

(76) Inventors: Richard Tonry, Austin, TX (US); Patrick Desbois, Austin, TX (US); Hans Eilers, Cedar Park, TX (US)

Correspondence Address: HAMILTON & TERRILE, LLP, P.O. BOX 203518, AUSTIN, TX, 78720, US

(21) Appl. No.: 11/830,880

(22) Filed: Jul. 31, 2007

(51) Int. Cl. F21V 8/00

(52) U.S. Cl. 340/815.75

(57) ABSTRACT

An information handing system which includes a processor, memory coupled to the processor, a chassis light device and a lighting control system coupled to the processor and the chassis light device. The lighting control system enables customizable control of the chassis light device.

### BACKGROUND OF THE INVENTION

1. Field of the Invention

The present invention relates to the field of information handling systems and more particularly to lighting devices used with information handling system chassis and still more particularly to user programmable architecture for control of a light device used with an information handling system chassis.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to provide an information handling system with a light device, such as a light emitting diode (LED), to display information, such as power status, floppy drive status, and the like. The light device provides a visual indication of the status of a device. For example, a light device might be used to indicate that power is present on the information handling system. Additionally, a light device might be used to indicate when a hard drive is being accessed.

Known light devices are generally controlled via the basic input output system (BIOS) of the information handling system based upon the status of the device for which the light device is meant to reflect status.

It would be desirable to provide a system and method for allowing customizable control of the light device.

### SUMMARY OF THE INVENTION

In accordance with the present invention, a system and method for allowing customizable control of the light device is set forth.

More specifically, in one embodiment, the invention relates to an information handing system which includes a processor, memory coupled to the processor, a chassis light device and a lighting control system coupled to the processor and the chassis light device. The lighting control system enables customizable control of the chassis light device

In another embodiment, the invention relates to a lighting control system which includes a chassis light device and a light controller. The light controller controls the chassis light device based upon input from a system controller, an audio controller and a user input device.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an information handling system.

FIG. 2 shows a block diagram of a light device within an information system.

FIG. 3 shows a block diagram of a lighting control system.

FIGS. 4A and 4B, generally referred to as FIG. 4, show diagrammatic block diagrams examples of chassis lights included within a portable information handling system.

### DETAILED DESCRIPTION

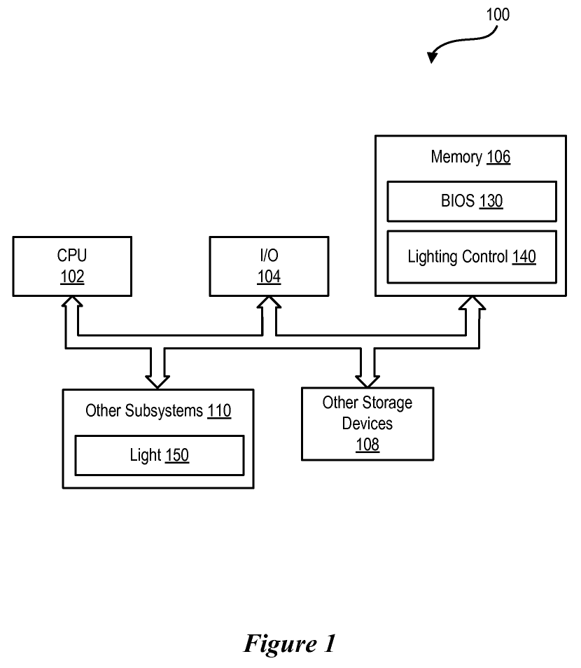

Referring to FIG. 1, a system block diagram of an information handling system 100 such as target information handling system 220 is shown. The information handling system 100 includes a processor 102, input/output (I/O) devices 104, such as a display, a keyboard, a mouse, and associated controllers, memory 106 including non-volatile memory such as a hard disk drive and volatile memory such as random access memory, and other storage devices 108, such as an optical disk and drive and other memory devices, and various other subsystems 110, all interconnected via one or more buses, shown collectively as bus 112. The memory 106 also includes a basic input output system 130 as well as a lighting control system 140. The other subsystems 110 include chassis lights 150 (such as e.g., light emitting diodes) which are positioned on the chassis of the information handling system 100.

The lighting control system 140 may be executed by the processor 102 to enable control of chassis lights 150.

The light control system 140 provides a complete and open user programmable architecture for customizable control of the chassis lights which can be used to illuminate the information handling system chassis.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

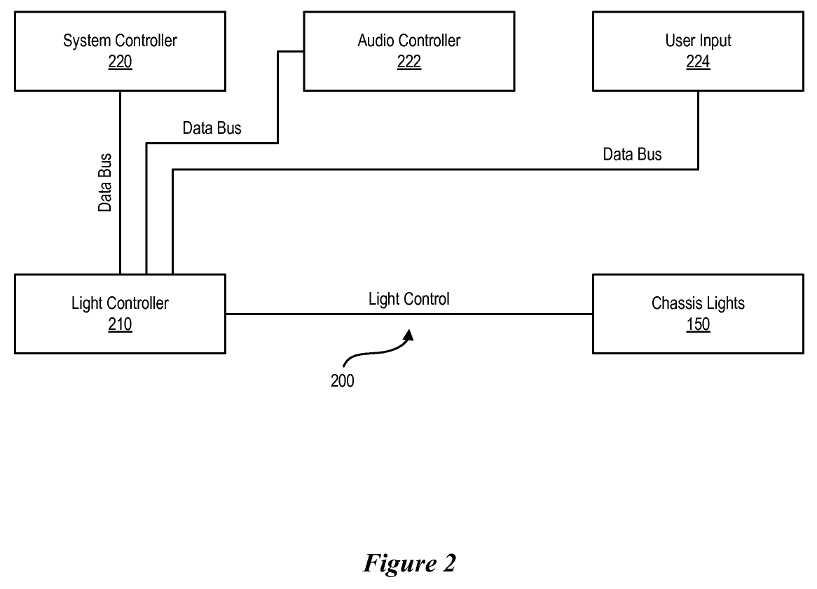

Referring to FIG. 2, a block diagram of a chassis light system within an information system is shown. The chassis light system 200 includes a light controller 210 as well as one or more light devices 150. The light controller 210 receives input information from a system controller 220 and an audio controller 222 as well as a user input device 224.

The lighting control system 140 also includes a BIOS to electrical Interface (i.e., a hardware interface). The hardware interface includes the light controller 210. The light controller 210 is controlled through the system interface (e.g., a system input output (SIO)) controller of the information handling system. The control is via an interface such as a system management bus (SMBus) or inter-integrated circuit (I²C) serial bus. The interface can be used to control the program selection of preprogrammed schemes on the light controller 210, as well as to allow user custom scripts to be programmed and downloaded to the light controller 210. The light controller 210 can interact with system events and software activities. For example, system events and software activities can include controlling lighting to follow audio output (including e.g., bass, frequency and volume), present lighting rotation of system events (including thermal warning, battery indications and performance indications), present and change the lighting to simulating following of user input via e.g., a touchpad or mouse.

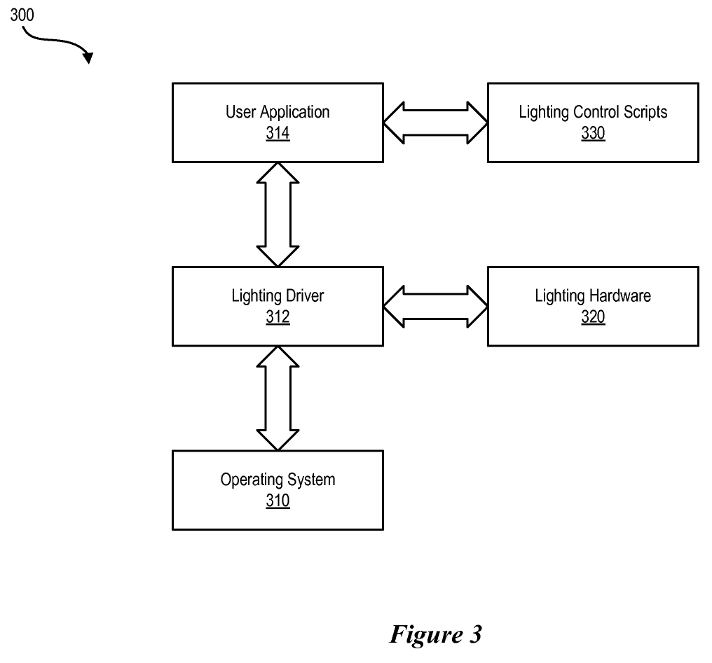

FIG. 3 shows a block diagram of interacting of lighting control system the 140 within a software stack 300. More specifically, the software stack 300 for the information handling system 100 includes an operating system 310, a lighting driver 312 and a lighting application 314. The lighting driver 312 interacts with lighting hardware 320 (including e.g., the light controller 210 and the chassis lights 150). The lighting application 314 interacts with the lighting driver as well as lighting control scripts 330.

More specifically, the lighting control user application 314 includes a user application graphical user interface (GUI) as well as a programming interface that generates a text based command script language, kernel mode device driver, and a BIOS-electrical interface. The kernel mode driver 312 includes a set of application program interfaces (APIs) for which a device developers kit (DDK) can be released to allow for the creation of drivers or plug-ins. The drivers and plug-ins allow applications such as the Windows Media Player application, the I-Tunes application and the MusicMatch application to interact with the chassis light 150. The applications can also include various games that would execute on the information handling system 100.

The lighting control user application 314 provides a GUI that allows a user to customize and control the light devices that are included within the information handling system. The lighting control user application 314 identifies a system chassis light configuration and presents a graphical representation of the system and the chassis light zones (i.e., light areas that can be controlled via the lighting control user application). The lighting control user application 314 allows users to make changes to and control the chassis lighting via radio buttons and check boxes.

The lighting control user application 314 generates a text script using a lighting control scripting language 330. The lighting control scripting language 330 can be saved and stored. The lighting control script can be manually generated or modified for advanced user control.

The kernel mode device driver 312 communicates directly with the BIOS 130 (or directly with the light controller 210). The kernel mode device driver 312 issues commands that control the light device. The kernel mode driver 312 supports a set of API calls that can be used in a DDK to create custom user mode drivers or plug-ins for other programs and devices. The kernel mode device driver 312 also communicates with the lighting control user application 314, passing along commands from the lighting control scripting language to the lighting hardware 320.

The lighting control scripting language 330 is an open set of text commands with full logic and control ability as well as macros for the processing of multiple light device control commands. Examples of command set functionality include light color, light intensity, light duration, fade control strobe control and wink control. Strobe is a flash on and off. Wink is a tapered on and off. The command set functionality or command set control may be different for different zones of light devices.

The lighting control system 140 enables chassis light control to be easily incorporated into software applications. By providing the lighting control system 140 with lighting control APIs, software applications can be configured to provide visual response and feedback to software events. Users could further customize interaction with the software applications via the light control scripts.

The lighting control system 140 can be configured to allow response and synchronization to audio sources. The response and synchronization to audio sources can include passive lighting effects cued and synchronized by either the frequency or amplitude of an audio source. Additionally, visual response can be programmed to activate on certain audio cues or sounds. The lighting control system driver interfaces with the software applications (e.g., game applications) to provide visual response to the software events.

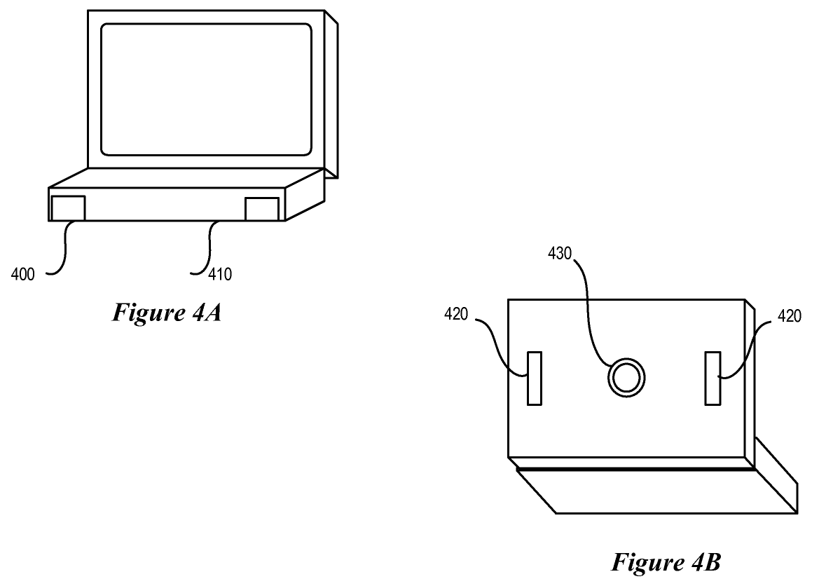

FIGS. 4A and 4B, generally referred to as FIG. 4, show diagrammatic block diagrams examples of chassis lights 150 included within a portable information handling system. More specifically, referring to FIG. 4A, chassis lights may be added to the front of a portable information handling system for decorative purposes. The chassis lights can be included within a speaker vent assembly 410.

Referring to FIG. 4B, in certain embodiments, the lighting control system 140 can be used to provide enhanced display backs (such as liquid crystal display (LCD) backs) that include lighted designs. The enhanced display backs can include illuminable portions 420 which are controllable via the lighting control system 140. The enhanced display back can also include an illuminable logo portion 430. The enhanced display back includes a connector that is incorporated into both the main display frame and the display back. Lighted designs can include a large vendor logo (such as e.g., a Dell logo), a Smiley Face, a skull, or possibly licensed team logos.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. An information handing system comprising:
a processor;
memory coupled to the processor;
a chassis light device;
a lighting control system coupled to the processor and the chassis light device, the lighting control system enabling customizable control of the chassis light device

2. The information handling system of claim 1 wherein the lighting control system further comprises:
a lighting control application, the lighting control application comprising a user interface, the user interface control enabling a user to control the chassis light device.

3. The information handling system of claim 1 wherein the lighting control system further comprises:
a lighting control device driver, the lighting control device driver issuing commands that control the chassis light device.

4. The information handling system of claim 3 wherein:
the lighting control device driver comprises lighting control application program interfaces, the lighting control application program interfaces allowing application programs to control the chassis light device.

5. The information handling system of claim 1 wherein the lighting control system further comprises:
a lighting control scripting language, the lighting control scripting language comprising an open set of text commands, the open set of text commands enabling a user to control the chassis light device.

6. The information handling system of claim 1 further comprising:
an enhanced display back, the enhanced display back comprising an illuminable portion, the illuminable portion being controlled via the lighting control system.

7. The information handling system of claim 1 further comprising:
an enhanced display back, the enhanced display back comprising an illuminable logo portion, the illuminable logo portion being controlled via the lighting control system.

8. A lighting control system comprising:
a chassis light device;
a light controller, the light controller controlling the chassis light device based upon input from a system controller, an audio controller and a user input device.

9. The lighting control system of claim 8 further comprising:
a lighting control application, the lighting control application comprising a user interface, the user interface control enabling a user to control the chassis light device.

10. The lighting control system of claim 8 further comprising:
a lighting control device driver, the lighting control device driver issuing commands that control the chassis light device.

11. The lighting control system of claim 10 wherein:
the lighting control device driver comprises lighting control application program interfaces, the lighting control application program interfaces allowing application programs to control the chassis light device.

12. The lighting control system of claim 8 further comprising:
a lighting control scripting language, the lighting control scripting language comprising an open set of text commands, the open set of text commands enabling a user to control the chassis light device.

13. The lighting control system of claim 8 wherein:
the chassis light device is within an enhanced display back, the chassis light device providing an illuminable portion, the illuminable portion being controlled via the light controller.

14. The lighting control system of claim 8 wherein:
the chassis light device is within an enhanced display back, the chassis light device providing an illuminable logo portion, the illuminable logo portion being controlled via the light controller.
